(19) United States
(12) Patent Application Publication
(10) Pub. No.: US 2018/0260853 A1
(43) Pub. Date: Sep. 13, 2018

(54) SYSTEMS, METHODS AND DEVICES FOR CONTENT BROWSING USING HYBRID COLLABORATIVE FILTERS

(71) Applicants: GM GLOBAL TECHNOLOGY OPERATIONS LLC, Detroit, MI (US); GENERAL MOTORS LLC, Detroit, MI (US)

(72) Inventors: Cagdas Karatas, Highland Park, NJ (US); Fan Bai, Ann Arbor, MI (US); Leonard C. Nieman, Harrison Township, MI (US)

(73) Assignees: GM GLOBAL TECHNOLOGY OPERATIONS LLC, Detroit, MI (US); GENERAL MOTORS LLC, Detroit, MI (US)

(21) Appl. No.: 15/457,280

(22) Filed: Mar. 13, 2017

(51) Int. Cl. G06Q 30/02

(52) U.S. Cl. CPC G06Q 30/0265

(57) ABSTRACT

Disclosed are algorithms for provisioning content browsing and personalized advertising using hybrid collaborative filters, electronic audiovisual systems implementing such browsing and advertising algorithms, and motor vehicles with onboard audiovisual infotainment systems for provisioning content browsing. A method is disclosed for provisioning content browsing to an occupant of a motor vehicle. The method includes: aggregating vehicle-related data and user-specific data associated with the motor vehicle and the occupant; creating a database of content data received from a distributed computer network; determining, via a Recommendation Engine, multiple recommendations by applying a hybrid collaborative filter to the stored content data based on the user-specific and vehicle-related data; transmitting the recommendations via a Dialogue Engine to the occupant through an electronic audiovisual system of the motor vehicle; and receiving one or more user selections of one or more of the transmitted recommendations from the occupant through the electronic audiovisual system.

### INTRODUCTION

The present disclosure relates generally to onboard vehicle devices for providing information to an occupant of a motor vehicle. More specifically, aspects of this disclosure relate to wireless-enabled audio and visual systems for browsing content from a distributed computer network in vehicular environments.

Current production motor vehicles, such as the modern-day automobile, are originally equipped with various types of onboard electronic devices to output information to vehicle occupants. Many modern-day automobiles, for example, are outfitted with an instrument cluster that communicates information to the driver regarding such things as vehicle speed, engine speed, fuel level, engine conditions, and other vehicle-related data. In addition to the instrument cluster, most automobiles also include as standard equipment an onboard audio system that operates alone or in conjunction with peripheral hardware to play music, output navigation instructions, receive voice commands, and/or provide other audio related functionality. Some motor vehicles are now equipped with a graphical user interface, such as a touchscreen video display panel, that is positioned in a center stack of the passenger compartment and is operable to receive user inputs and display image, text, and video-based content. In-vehicle audiovisual (AV) hardware that delivers entertainment and informational content is collectively referred to in the art as an integrated “infotainment” system.

Onboard vehicle devices may output content that is based, for example, on data received from a local device, such as a GPS navigation receiver or digital audio file player, as well as data received from a remote device, such as a radio transmitter or satellite broadcast service. Some devices are even able to receive data from a distributed computer network—the most ubiquitous being the global Internet—over a wireless fidelity (WiFi) system, cellular network, or other wireless data exchange technology. Content that is output based on data received over a wireless network may, for example, include video (e.g., streaming television, movies, video clips, etc.), audio (e.g., Internet radio, podcasts, audio books, etc.), print media, social media, mobile phone media, and innumerable other types of information. Many vehicles now support seamless integration of a smartphone with the vehicles' infotainment systems, which allows occupants to access email, the World Wide Web, and, of course, use as a phone.

There is an ever-increasing volume of media, such as music, books, videos, news, and other content, that can now be accessed from the Internet by onboard vehicle electronic devices. Existing internet service providers (ISP) are capable of presenting, in real-time, the details of tens of millions of songs, movies, news articles, webpages, television show episodes, social media content, etc., while a motor vehicle is in transit. The collection of source content is growing with the continual addition of new items as well as the development and adoption of new content technologies. As such, a vehicle occupant faces a significant investment of time and attention to search and select content during use of the motor vehicle. In addition, many users' preferences change with time, which will likely render some content outdated and, thus, require additional time and effort to update content and preferences.

### SUMMARY

Disclosed herein are computer-implemented algorithms for provisioning content browsing and personalized advertising using hybrid collaborative filters, enhanced electronic audiovisual systems with an AV controller for implementing such content browsing and personalized advertising, and motor vehicles with an in-vehicle audiovisual infotainment system for provisioning content browsing and personalized advertising. By way of example, and not limitation, there is presented a novel method for providing an occupant with personalized content (e.g., news, webpages, music and other content like POIs), and enabling implicit socialization among drivers through content recommendation. With user participation and consent, the content recommendation method can suggest content to a particular user based on: (1) the user's subjective interests; (2) an interest-based social group with which the user is associated; (3) changes in the interests of the user; (4) changes in the interests of similar users; (5) the interests of the user's friends; and/or (6) other users within a predetermined vicinity of the user. A Recommendation Engine receives, as data-reference inputs, a user's preferences, locality data for users in proximity to the user, car context data with vehicle-related information, and preferences of users with known similar interests. The Recommendation Engine searches a content database generated, e.g., by a web scraper, to output multiple recommendations. These recommendations are fed to a Scheduling & Order (S&O) Engine, which creates a merged list of user tasks and recommendation tasks based on business logic, locality and context data. A Dialog Engine transmits the S&O Engine output to the user with a text-to-speech (TTS) engine. The system uses speech recognition software to recognize voice commands received from an occupant to navigate through the dialog graph and to receive user selections.

Attendant benefits for at least some of the disclosed concepts include the ability to provide occupants with personalized content (news, webpages, music, and other personalized content), and to enable implicit socialization among drivers through content recommendations. Other resultant benefits may include provisioning of audio browsing of webpages in vehicular environments without distracting drivers and occupants from higher priority tasks. Additional advantages may include providing an implicit socialization platform among drivers through social-interest-based content recommendations. Disclosed systems, methods and devices also provide personalized and up-to-date content that can facilitate implicit interactions among users with a hybrid Recommendation Engine.

Aspects of the present disclosure are directed to computer-implemented algorithms for provisioning content browsing and personalized advertising using hybrid collaborative filters. Disclosed, for example, is a method for provisioning content browsing to an occupant of a motor vehicle. The vehicle includes an onboard electronic audiovisual system that is communicatively connected to a distributed computer network. This method includes, in any order and in any combination with any of the disclosed features and options: receiving, via a Recommendation Engine, user-specific data associated with the occupant of the motor vehicle; receiving, via the Recommendation Engine, content data directly or indirectly from the distributed computer network; determining, via the Recommendation Engine, a plurality of recommendations by applying a hybrid collaborative filter to the received content data based on the received user-specific data; transmitting, via a Dialogue Engine, the recommendations to the occupant through the electronic audiovisual system of the motor vehicle; and, receiving a user selection from the occupant of one or more of the transmitted recommendations via the Dialogue Engine through the electronic audiovisual system,.

Determining the recommendations for the occupant may include calculating a sum of weighted averages of an interest vector for a plurality of individual interests. The individual interests may include similar user data indicative of interests of one or more similar users; in this instance, the method may further include calculating a similarity measure between the occupant and each of the similar users. The individual interests assessed by the sum of weighted averages may further include any of the interests enumerated above and below. As another optional operation, the method may also include determining, via a Scheduling & Ordering engine, an order of priority of the recommendations by assigning a priority indication and a time indication to each of the recommendations. In this instance, the recommendations are transmitted to the occupant in the determined order of priority. In some embodiments, determining the recommendations for the occupant is further based on vehicle-specific data associated with the motor vehicle occupied by the occupant.

Other aspects of the present disclosure are directed to motor vehicles with an onboard audiovisual infotainment system operable for provisioning any of the disclosed content browsing schemes. A “motor vehicle,” as used herein, may include any relevant vehicle platform, such as passenger vehicles (internal combustion engine, hybrid electric, full electric, fuel cell, fuel cell hybrid, fully or partially autonomous, etc.), commercial vehicles, industrial vehicles, tracked vehicles, off-road and all-terrain vehicles (ATV), farm equipment, boats, airplanes, etc. The audiovisual infotainment system may include a high-resolution touchscreen display, an audio speaker component package, and/or a programmable AV controller, which may be resident to or remote from the vehicle.

Additional aspects of this disclosure are directed to enhanced audiovisual infotainment systems for implementing any of the disclosed content browsing and personalized advertising processes. In a non-limiting example, there is disclosed an electronic audiovisual system for a motor vehicle. The audiovisual system includes an electronic input device, such as a microphone and/or button panel, and an electronic output device, such as a display screen and/or one or more audio speaker components. An audiovisual (AV) electronic control unit (ECU) is communicatively connected to the electronic input device(s), the electronic output device(s), and a distributed computer network, such as the Internet. This ECU is programmed to execute one or more processor-executable modules the instructions to: receive user-specific and/or vehicle-related data associated with the occupant and the motor vehicle; receive content data directly or indirectly from the distributed computer network; determine various content recommendations for an occupant by applying a hybrid collaborative filter to the received content data based on the received user-specific and/or vehicle-related data; transmit the recommendations to the occupant, e.g., with a text-to-speech (TTS) engine; and receive a user selection of one or more of the available content recommendations. The AVECU may be further programmed to execute any of the other operations disclosed herein.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram of a representative vehicle infotainment system with an onboard or remote AV controller for provisioning content browsing and personalized advertising to a passenger of a vehicle using hybrid collaborative filters in accordance with aspects of the present disclosure.

FIG. 2 is a workflow diagram of a representative hybrid collaborative filter for generating prospective content recommendations via a representative Recommendation Engine in accord with aspects of the disclosed concepts.

FIG. 3 is a workflow diagram illustrating operations for creating a prioritized list of user tasks and recommendation tasks via a representative Scheduling & Ordering Engine in accordance with aspects of the present disclosure.

FIG. 4 is a workflow diagram of a representative dialogue graph format created via a representative Audio Browsing Dialogue Engine in accord with aspects of the disclosed concepts.

The present disclosure is susceptible to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, subcombinations, permutations, groupings, and alternatives falling within the scope and spirit of the disclosure as defined by the appended claims.

### DETAILED DESCRIPTION

This disclosure is susceptible of embodiment in many different forms. There are shown in the drawings and will herein be described in detail representative embodiments of the disclosure with the understanding that these representative embodiments are to be considered an exemplification of the principles of the disclosure and are not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, may be used herein in the sense of “at, near, or nearly at,” or “within 3-5% of,” or “within acceptable manufacturing tolerances,” or any logical combination thereof, for example.

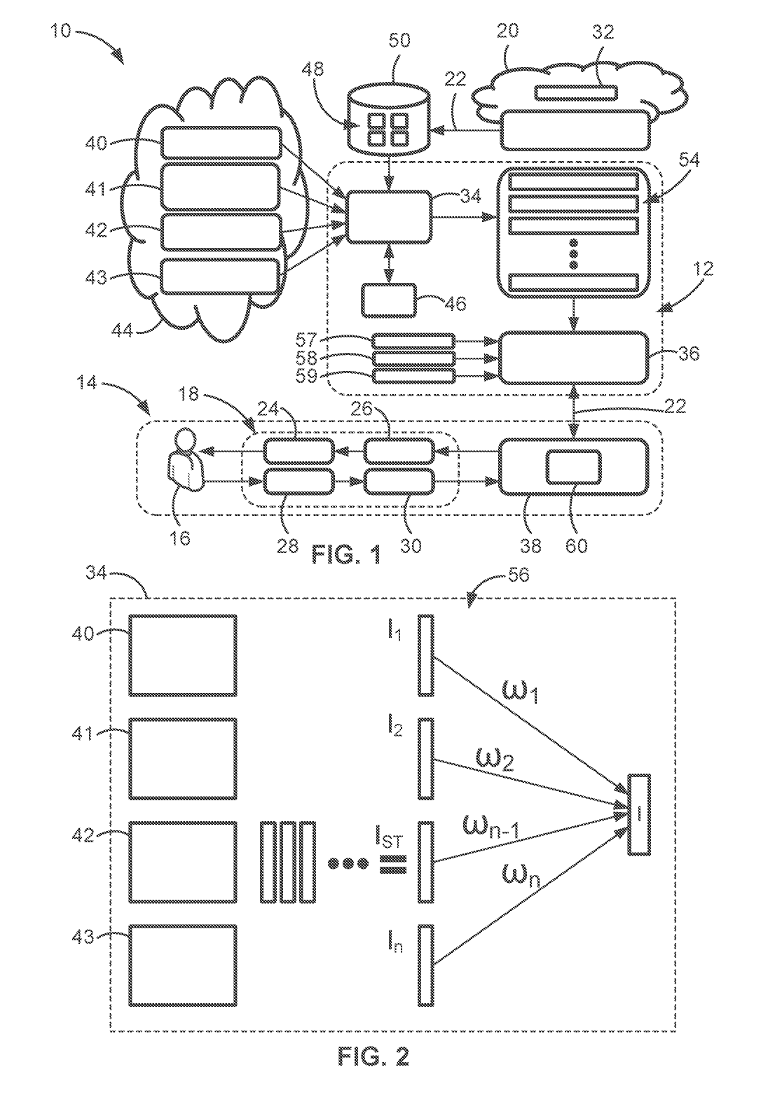

Referring now to the drawings, wherein like reference numbers refer to like features throughout the several views, there is shown in FIG. 1 a schematic illustration of a representative multimodal computer-networked vehicle infotainment architecture, designated generally at 10, for provisioning content browsing and personalized advertising using hybrid collaborative filters. The illustrated vehicle infotainment architecture 10 is merely an exemplary application with which the novel aspects and features of this disclosure may be practiced. In the same vein, implementation of the present concepts by an audiovisual (AV) controller 12 for a driver 16 of a privately owned passenger vehicle 14 should also be appreciated as an exemplary application of the novel concepts disclosed herein. As such, it will be understood that aspects and features of the present disclosure may be applied to for any occupant of any logically relevant motor vehicle, and implemented by other infotainment system architectures. Moreover, only select components of the architecture 10 have been shown and will be described in additional detail herein. Nevertheless, the architectures, systems, and devices discussed herein can include numerous additional and alternative features, and other well-known peripheral components, for example, for carrying out the various methods and functions of this disclosure. Lastly, the drawings presented herein are not necessarily to scale and are provided purely for instructional purposes. Thus, the specific and relative dimensions shown in the drawings are not to be construed as limiting.

In the representative framework presented in FIG. 1, the vehicle infotainment architecture 10 is part of a distributed computing network operable for transacting data over a wireless communications system using onboard “in-vehicle” electronic devices and off-board “remote” electronic devices. As shown, an AV controller 12, which may be resident to or remote from the body of the vehicle 14, communicates with an in-vehicle infotainment system 18 of the vehicle 14 and one or more remote sources of content 20, such as the World Wide Web (WWW), e.g., via a communications network 22. The illustrated example portrays a single driver—a private individual—operating and interacting with an onboard infotainment system 18 that is generally composed of one or more output devices, such as a touchscreen video display panel 24 and one or more audio speaker components 26, and one or more input devices, such as a microphone 28, a button panel 30, and the touchscreen display panel 24. However, it is envisioned that the vehicle infotainment architecture 10 may interact with any occupant of vehicle 14, and may employ any now known or hereafter developed electronic input and output devices.

The communications network 22 of FIG. 1 can be a wired network or a wireless network, or a combination of wired and wireless technology. It may be desirable, for at least the illustrated example, that most if not all of the transactions performed by the AV controller 12 be conducted “wirelessly” over a wireless network, such as a WLAN or cellular data network, to ensure freedom of movement of the driver and any occupants of vehicle 14. In some implementations, one or more segments of the architecture 10 can be embodied as web-based components where users or clients use internet-based websites and/or web-based applications to access the transaction features disclosed herein. In various aspects, the vehicle infotainment system 18 includes a web browser or a dedicated, standalone application software, or a combination of both. A web browser typically allows a user to search for and/or request a web page (e.g., from the WWW or other remote source of content 20) with a web page request. A web page, in a non-limiting example, is a data file that includes computer executable or interpretable data, graphics, text, video, and/or sound, that can be executed, displayed, played, processed, streamed, and/or stored, and that can contain links to other web pages. Examples of commercially available web browser software include, but are certainly not limited to, FIREFOX, available from Mozilla Corp., SAFARI available from Apple, Inc., ANDROID BROWSER, available from Google Inc., and INTERNET EXPLORER, available from Microsoft Corp.

Dedicated application software can be implemented for completing operations by and interactions between the various users and various components of the architecture 10. For instance, the dedicated application software can be in the form of a web-based (e.g., Java) applet that is downloaded to an onboard electronic device and runs in conjunction with a web browser on the device. Optionally, the dedicated application software can be in the form of a standalone software application, which can be implemented in a multi-platform language such as .Net or Java, or in native processor executable code. In at least some embodiments, the dedicated application software communicates with a single “host” or “client” server, such as a back-office intermediary server, which in turn conducts any necessary communications with one or more “third party” servers to complete a particular transaction. Optionally, the dedicated application software and web browser can be part of a single client-server interface, where the software can be implemented as a “plug-in” to the web browser, for example. As another option, this software application can be embodied as a dedicated mobile software application (more commonly known as a “mobile app” or just “app”) that is downloaded to or otherwise available on an onboard electronic device, e.g., as a standard feature with the device's operating system. Other optional variations and known alternatives are considered to be within the scope and spirit of the present disclosure.

In the illustrated system, the network 22 securely communicatively couples the AV controller 12 to one or more servers 32 operable for provisioning remote sources of content 20. Each server can be implemented on one or more server class computers, which can be subcomponents of a computer hardware server system, with sufficient memory, data storage, and processing power and, in some embodiments, the capabilities to run a server class operating system (e.g., GNU/Linux, SUN Solaris, Microsoft Windows OS, etc.). The servers can each be part of a logical group of one or more servers, such as a server farm or server network or server stack. As is typical in large-scale systems, the application software can be implemented in components, with different components running on different server computers, on the same server, or any logical combination thereof. A server stack may include any suitable processor(s), such as those made by Intel and AMD, that communicates with an auxiliary or main memory device. By way of example, the server stack includes a plurality of microprocessors including a master processor, a slave processor, and a secondary or parallel processor. Each memory device may take on the form of any of a variety of memory media, such as CD-ROM, magnetic disk, bubble memory, and semiconductor memory (e.g., various types of RAM or ROM).

With continuing reference to FIG. 1, vehicle infotainment architecture 10 is operable for provisioning content browsing and personalized advertising for a driver 16 and/or other occupants of a motor vehicle 14 using a hybrid collaborative filter, examples of which will be described in further detail below. In so doing, the driver/occupant 16 is provided with personalized content (e.g., news, music, webpages, social media, point of interest (POI) materials, and/or other content), optional tailored advertising, and implicit socialization with other drivers/occupants through content recommendations generated by the AV controller 12. In the illustrated example, portions of the vehicle infotainment architecture 10 are shown generally embodied as interoperable software control modules or “engines”—a Recommendation Engine 34, a Scheduling & Ordering Engine 36, and a Dialogue Engine 38—that may each comprise a respective software application with processor-executable instructions effectuated, for example, by the AV controller 12, which itself may be in the nature of an electronic control unit or other computer-implemented platform. In the same vein, it is envisioned that each control module/engine may comprise a discrete controller, microprocessor or other integrated circuit (IC) device, all of which are operatively interconnected to carry out any of the functions and features disclosed herein.

During operation of the vehicle infotainment architecture 10, the Recommendation Engine 34 determines or otherwise receives user-specific data associated with the driver/occupant 16 and, for some applications, vehicle-specific data associated with the motor vehicle 14. This may necessitate the Recommendation Engine 34 access, request, and retrieve the requisite data from one or more storage modules 40-43 in a remote user database or cloud-computing data center 44. Received data may include, singly, collectively, or in any combination: (1) user data that is collected in a user storage module 40 and is indicative of subjective interests of the driver/occupant; (2) locality data that is stockpiled in a locality storage module 41 and is indicative of interests of persons at a specific location and/or within a predetermined proximity or of the occupant; (3) similar user data that is stored in a similar user storage module 42 and is indicative of the interests of one or more users with interests similar to those of the driver/occupant; and (4) vehicle-specific data that is collected in a vehicle context storage module 43 and is indicative of vehicle-related information, such as vehicle speed, vehicle location, tire pressure(s), fuel level, and/or one or more engine operating conditions (e.g., service engine, oil change, etc.). It is envisioned that the Recommendation Engine 34 receive fewer, additional or alternative data from that which is described above and illustrated in the drawings. Moreover, while described as being stored in a remote user database/data center 44, any or all of the storage modules 40-43 may be contained within an auxiliary or main memory device 46 resident to the AV controller 12 or packaged in another peripheral component within the vehicle 14.

Prior to, contemporaneous with, or subsequent to receiving user-specific and/or vehicle-specific data, the Recommendation Engine 32 also identifies or otherwise receives content data 48, either directly or indirectly, from the remote source(s) of content 20 and, optionally, from local sources of content. According to the illustrated example, at least a portion of the content data 48 is accumulated via a dedicated web scraper 52 that is operable to search one or more websites accessible on the distributed computer network to retrieve and store content in a content database 50. A key element that helps to distinguish data scraping from regular program-to-program data parsing is that the output being “scraped” is formatted for presentation to an end-user, rather than solely as input to another program. Some of the challenges with conventional data scraping applications is that there are many irrelevant meta tags, ads, etc. in HTML, and there is typically no unique tag for identifying paragraphs due to sheet language styling (e.g., Cascading Style Sheets (CSS)). During data scraping, the web scraper 52 of FIG. 1, however, is operable to identify tags or other meta elements that isolate relevant content on a website, and identify text content within the relevant content that can be transmitted audibly to the occupant. In effect, the data scraping content retrieval process finds specific content that can be read out, displayed, or otherwise presented to a user. It is also envisioned that content can be extracted from other local and remote sources, including smartphones, digital audio file (MP3) players, handheld tablet computers, satellite broadcast services, resident memory, etc.

Once all necessary data is accumulated, the Recommendation Engine 34 determines a set of potential recommendations 54 for presentment to the driver/occupant 16 of the motor vehicle 14, e.g., by applying a hybrid collaborative filter to the received content data based on the user-specific and/or vehicle-specific data. By way of non-limiting example, the hybrid collaborative filter may be designed to account for current user preferences, preference changes over time, preference trends, content from similar or otherwise relevant people, vehicle-related information, etc., by employing a combination of a modified interest-based filter and a modified collaborative filter. FIG. 2 illustrates a representative hybrid collaborative filter, designated generally at 56, for generating prospective content recommendations for a vehicle occupant. In this instance, the hybrid collaborative filter 56 accounts for any combination of user data 40 (e.g., the user's individual interests), locality data 41 (e.g., interests of users in the vicinity), similar user data 42 (e.g., interests of users in the user's online social network or a designated group with known similar interests), and/or vehicle-specific data 43 (e.g., the vehicle is speeding, is running low on gas, has a flat tire, etc.). The user, groups, similar users, etc., can each be represented as a vector of interests Iᵢ—the hybrid collaborative filter 56 is shown in FIG. 2 calculating a sum of weighted averages of an interest vector I for the user-specific data as:

$$I = \frac{{\sum }_{i ∈ G} {ω}_{i} {I}_{i}}{{\sum }_{i ∈ G} {ω}_{i}}$$

where Iᵢ is indicative of a plurality of individual interests I₁, I₂, I₃. . . Iₙ contained in the user-specific and vehicle-specific data, and co, is indicative of respective weight vectors ω₁, ω₂, ω₃. . . ωₙ con associated with the individual interests. I_{ST} of FIG. 1 is intended to be indicative of an aggregate of various interests of numerous similar users. In conventional systems, lack of user feedback can be an issue; by prompting for updated information and enforcing social interactions, disclosed methodologies help to increase the volume of user feedback.

Continuing with reference to both FIGS. 1 and 2, the system 10 may wish to calculate a similarity measure between the targeted user and other similar or local users and, optionally, find a number K of closest “neighbors” (e.g., like-mind users, interest groups, local drivers, etc.) of the targeted user. A similarity measure Sim(Uᵢ, Uⱼ) between the occupant Uᵢ and the similar user Uⱼ may be calculated as:

$$Sim ( {U}_{i} , {U}_{j} ) = \frac{{\sum }_{{a}_{l} ∈ A} [ r ( {U}_{i} , {a}_{l} ) - \overline{r} ( {U}_{i} ) ] [ r ( {U}_{j} , {a}_{l} ) - \overline{r} ( {U}_{j} ) ]}{\sqrt{{\sum }_{{a}_{l} ∈ A} {[ r ( {U}_{i} , {a}_{l} ) - \overline{r} ( {U}_{i} ) ]}^{2}} \sqrt{{\sum }_{{a}_{l} ∈ A} {[ r ( {U}_{i} , {a}_{l} ) - \overline{r} ( {U}_{i} ) ]}^{2}}}$$

where r is a rating function of a user, r̅ is a mean of all ratings for aᵢ user, and a is a particular piece of content. For example, r(U₁, a₅) is a rating by user U₁ of a news article a₅, and r̅ (U₁) is the mean of all ratings by user U₁. The denominator portion of the above-equation helps to normalize the similarity measure.

Vehicle infotainment architecture 10 may be further operable to assess future trends, identify breaks from prior trends, and generate predictions for projected interests. It is expected that each user's interests will change over time; consequently, the user may belong to different interest groups at different times, associate with new/different social media websites, identify with new/different music, television, or other media trends. In the same vein, the collective interest of an interest group might change or evolve with trends. Conversely, a user's history of interests and related interest groups may have a residual effect on future interests; as such, future interests may be estimated from old interests and/or interest group memberships. An change in interests over time I_{ST}(t) can be calculated as:

$${I}_{ST} ( t ) = {\sum }_{i} \frac{{I}_{S} ( {t}_{i} , t )}{t - {t}_{i}}$$

where I_{S} is indicative of an interest vector of the group; tᵢ is indicative of a time instance in the past; and t is indicative of a current time. In this instance, I_{S}(tᵢ,t) represents current interests of the group that user used to belong at time tᵢ. The denominator in the above-referenced equation helps to balance if a threshold “too much” amount of time has passed.

It may be desirable, for at least some applications, that the system 10 adjust group weights over time based on user feedback. As time passes, the importance (“weight”) of a particular group to a user might change; the assessed weight can be recalculated based on implicit/explicit feedback from a user as:

ω_{i,u}⁺=ω_{i,u}+(error×Iᵢ)

where ω_{i,u} is indicative of a current weight for user u of an i^{th} group; ω_{i,u}⁺ is indicative of a new “updated” weight; and Iᵢ is indicative of an interest vector of the i^{th} group. An assessed weight for a user/group can be improved from a user's feedback (I_{f}) to the content (I_{c}) with back propagation: compute error=(I_{c}-I_{f}); compute a new weight ω_{i,u}⁺ from a prior weight ω_{i,u}.

Content recommendations 54, once generated, are transmitted to a Scheduling & Ordering Engine 36 that creates, for example, a merged list of user tasks and recommendation tasks based on business logic 57, locality data 58 and context data 59. Context data may indicate the current context of vehicle status, driver/passenger status and/or environmental status. Vehicle context data may be abstracted and synthesized based on the vehicle CANBus data using a predetermined set of rules designed by the domain experts. By way of example, and not limitation, the Scheduling & Ordering Engine 36 may define an order of priority of the generated recommendations by assigning a priority indication and a time indication to each of the recommendations, and transmit the recommendations to the driver and/or occupant(s) through the electronic audiovisual system 18 in the order of priority. In a more specific example, every Task i has the following fields: (1) Priority (p(i)): a metric of importance for that task; (2) Time constraint (TC(i)): a time interval during which the task should to be completed; and (3) Required Time (RT(i)): a duration of time needed to complete the task. The Priority (p(i)) metric of importance can be defined based on the inputs 57-59, each of which may contain discrete information and/or may mimic data from its corresponding counterpart in database/data center 44, to schedule tasks, whether it be user tasks or recommendation tasks.

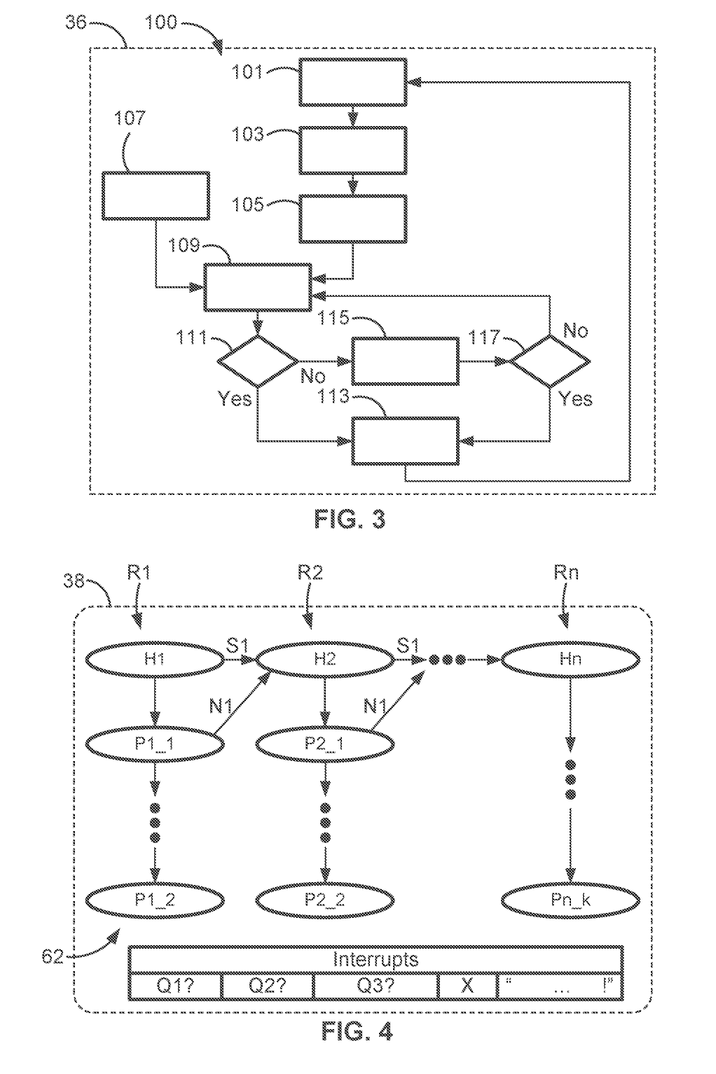

FIG. 3 illustrates a series of representative operations for creating a prioritized list of user tasks and recommendation tasks via a Scheduling & Ordering Engine. Some or all of the operations portrayed in the drawings and described herein can be representative of an algorithm or method 100 that corresponds to processor-executable instructions that can be stored, for example, in main or auxiliary memory, and executed, for example, by an ECU, a CPU, a dedicated server component, an on-board or remote control logic circuit, or other device, to perform any or all of the above and/or below described functions associated with the disclosed concepts. The method 100 begins at block 101 with generating, accessing or otherwise determining a priority que of unfinished tasks. At block 103, the Scheduling & Ordering Engine 36 extracts a predetermined number of the highest priority—“most important”—tasks for a que(POP). From this que, the method 100 identifies, at block 105, a top-most unscheduled task and systematically attempts, at block 109, to fit each task into a complementary or a longest free timeslot (available space) identified in the user's schedule, which is generated, accessed or otherwise determined at block 107.

Continuing to block 111, the method 100 determines if the unscheduled task can fit into the available timeslot; if the task fits (Block 111=YES), Engine 36 reserves this space for this task at block 113, and loops back to the beginning of the algorithm 100 to schedule the next-in-line top-most unscheduled task. If the task does not fit into an available timeslot (Block 111=NO), Engine 36 adjusts the schedule of one or more neighboring tasks, at block 115, to provide additional time for the current task. After this, the method 100 determines, at block 117, if the unscheduled task can now fit into the modified available timeslot; if the task fits (Block 117=YES), Engine 36 reserves this space for this task at block 113, and loops back to the beginning of the algorithm 100 to schedule the next-in-line top-most unscheduled task. If the task does not fit into the modified available timeslot (Block 117=NO), the method 100 returns to block 109 and attempts to identify the next longest free space in user's schedule. It should be recognized that the order of execution of the blocks illustrated in FIG. 3 may be changed, and/or some or all of the blocks shown may be modified, eliminated, combined, or supplemented to include any of the other options and features discussed above and below.

Referencing back to FIG. 1, a Dialogue Engine 38 functions, at least in part, to transmit the proposed recommendations to the occupant, e.g., through the output devices 24, 26 of the electronic audiovisual system 18. According to the illustrated example, each recommendation is transmitted from the Recommendation Engine 34, through the Scheduling & Ordering Engine 36, to the Dialogue Engine 38 in data files. Each of these data files may include at least a text portion and a tag portion. The Dialogue Engine 38 of FIG. 1 incorporates or communicates with a complementary text-to-speech (TTS) engine 60 that is operable to convert each text portion of a data file into a respective audio file. Optional configurations may implement other known software or hardware features for the artificial production of human speech, such as a dedicated speech synthesis software application. Presenting the recommendations to the driver/occupant may require the Dialogue Engine 38 generate or otherwise determine a dialog graph that links different contents and navigation options, an example of which is shown at 62 in FIG. 4. As shown, respective content headers H1, H2 . . . Hn and respective navigation options, such as NEXT N1, SKIP S1, are provided for a plurality of recommendation data files R1, R2 . . . Rn containing content (paragraphs) P1_1, P2_2 . . . Pn₋k. The dialogue graph 62 is created to link together related content headers such that the data files are searchable via the navigation options. For at least some preferred embodiments, the dialogue graph 62 is not displayed to the driver or occupant(s); rather, it is read out to user based on the user's voice commands. These voice commands can include, as some non-limiting examples: Q1?=“who is” performing a particular piece, or “who wrote” a particular piece, or “who owns” or is disseminating a particular piece of content; Q2?=“what is” the title or type or origin of a particular piece; Q3?=“news about” to identify the topic or subject matter of a particular piece; X=“stop”; or “. . . !” to leave a comment or feedback or a rating. The Dialogue Engine 38, in addition to commands and feedback, is also operable to receive one or more user selections of the transmitted recommendations from the occupant through the electronic audiovisual system.

Aspects of this disclosure may be implemented, in some embodiments, through a computer-executable program of instructions, such as program modules, generally referred to as software applications or application programs executed by an on-board vehicle computer. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

While aspects of the present disclosure have been described in detail with reference to the illustrated embodiments, those skilled in the art will recognize that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined in the appended claims. Moreover, the present concepts expressly include any and all combinations and subcombinations of the preceding elements and features.

What is claimed:

1. A method for provisioning content browsing to an occupant of a motor vehicle, the motor vehicle including an electronic audiovisual system communicatively connected to a distributed computer network, the method comprising:
receiving, via a Recommendation Engine, user-specific data associated with the occupant of the motor vehicle;
receiving, via the Recommendation Engine, content data from the distributed computer network;
determining, via the Recommendation Engine, a plurality of recommendations by applying a hybrid collaborative filter to the received content data based on the received user-specific data;
transmitting, via a Dialogue Engine, the plurality of recommendations to the occupant through the electronic audiovisual system of the motor vehicle; and
receiving, via the Dialogue Engine from the occupant through the electronic audiovisual system, a user selection of at least one of the transmitted recommendations.

2. The method of claim 1, wherein the determining the recommendations includes calculating a sum of weighted averages of an interest vector I for the user-specific data as:
$$I = \frac{{\sum }_{i ∈ G} {ω}_{i} {I}_{i}}{{\sum }_{i ∈ G} {ω}_{i}}$$
where Iᵢ is indicative of a plurality of individual interests I₁, I₂, I₃. . . Iₙ contained in the user-specific data, and ωᵢ is indicative of respective weight vectors ω₁, ω₂, ω₃. . . ωₙ associated with the multiple individual interests.

3. The method of claim 2, wherein the individual interests contained in the user-specific data include user data indicative of subjective interests of the occupant, locality data indicative of interests of persons within a predetermined proximity of the occupant, similar user data indicative of interests of users with interests similar to those of the occupant, or vehicle-specific data specific to the motor vehicle, or any combination thereof.

4. The method of claim 2, wherein the individual interests include similar user data indicative of interests of a similar user, the method further comprising calculating a similarity measure Sim(Uᵢ, Uⱼ) between the occupant Uᵢ and the similar user Uⱼ as:
$$Sim ( {U}_{i} , {U}_{j} ) = \frac{{\sum }_{{a}_{l} ∈ A} [ r ( {U}_{i} , {a}_{l} ) - \overline{r} ( {U}_{i} ) ] [ r ( {U}_{j} , {a}_{l} ) - \overline{r} ( {U}_{j} ) ]}{\sqrt{{\sum }_{{a}_{l} ∈ A} {[ r ( {U}_{i} , {a}_{l} ) - \overline{r} ( {U}_{i} ) ]}^{2}} \sqrt{{\sum }_{{a}_{l} ∈ A} {[ r ( {U}_{i} , {a}_{l} ) - \overline{r} ( {U}_{i} ) ]}^{2}}}$$
where r is a rating function of a user, r̅ is a mean of all ratings for a user, and aᵢ is a particular piece of content.

5. The method of claim 1, further comprising determining, via a Scheduling & Ordering engine, an order of priority of the plurality of recommendations by assigning a priority indication and a time indication to each of the recommendations, wherein the recommendations are transmitted to the occupant through the electronic audiovisual system in the order of priority.

6. The method of claim 1, wherein the receiving the user selection includes receiving multiple user selections of multiple ones of the transmitted recommendations, the method further comprising creating a priority que of the selected recommendations, and scheduling a time to present each of the selected recommendations.

7. The method of claim 1, further comprising receiving vehicle-specific data associated with the motor vehicle, wherein the determining the recommendations is further based on the received vehicle-specific data.

8. The method of claim 7, wherein the vehicle-specific data includes a vehicle speed, a vehicle location, a tire pressure, a fuel level, or an engine operating condition, or any combination thereof.

9. The method of claim 1, wherein the user-specific data includes user data indicative of subjective interests of the occupant, locality data indicative of interests of persons within a predetermined proximity of the occupant, or similar user data indicative of interests of users with interests similar to those of the occupant, or any combination thereof.

10. The method of claim 1, further comprising:
tracking a history of interests of the occupant of the motor vehicle; and
calculating a change in interests over time as:
$${I}_{ST} ( t ) = {\sum }_{i} \frac{{I}_{S} ( {t}_{i} , t )}{t - {t}_{i}}$$
where I_{ST}(t) is indicative of the change in interests over time, and I_{S} (tᵢ, t) is indicative of an interest at time tᵢ and at time t.

11. The method of claim 1, further comprising:
determining respective content headers and navigation options for a plurality of data files in the content data received from the distributed computer network; and
creating a dialogue graph linking together related ones of the content headers such that the data files are searchable via the navigation options.

12. The method of claim 1, wherein at least a portion of the content data is accumulated via a web scraper operable to search a plurality of websites accessed through the distributed computer network, identify tags that isolate relevant content on the websites, and identify text content within the relevant content that can be transmitted audibly to the occupant.

13. The method of claim 1, further comprising transmitting the recommendations from the Recommendation Engine to the Dialogue Engine in data files, the data files each including a text portion and a tag portion, wherein the Dialogue Engine includes a text-to-speech (TTS) engine operable to convert each of the text portions into a respective audio file.

14. An electronic audiovisual system for a motor vehicle, the electronic audiovisual system comprising:
an electronic input device operable to receive user inputs from an occupant of the motor vehicle;
an electronic output device operable to transmit audio content or video content, or both, to the occupant of the motor vehicle; and
an audiovisual electronic control unit communicatively connected to the electronic input device, the electronic output device, and a distributed computer network, the electronic control unit being configured to:
receive user-specific data associated with the occupant of the motor vehicle;
receive content data from the distributed computer network;
determine a plurality of recommendations by applying a hybrid collaborative filter to the received content data based on the received user-specific data;
transmit the plurality of recommendations to the occupant; and
receive a user selection of at least one of the transmitted recommendations.

15. The electronic audiovisual system of claim 14, wherein the determining the recommendations includes calculating a sum of weighted averages of an interest vector I for the user-specific data as:
$$I = \frac{{\sum }_{i ∈ G} {ω}_{i} {I}_{i}}{{\sum }_{i ∈ G} {ω}_{i}}$$
where Iᵢ is indicative of a plurality of individual interests I₁, I₂, I₃. . . Iₙ contained in the user-specific data, and ωᵢ is indicative of respective weight vectors ω₁, ω₂, ω₃. . . ωₙ associated with the multiple individual interests.

16. The electronic audiovisual system of claim 15, wherein the individual interests contained in the user-specific data include user data indicative of subjective interests of the occupant, locality data indicative of interests of persons within a predetermined proximity of the occupant, similar user data indicative of interests of users with interests similar to those of the occupant, or vehicle-specific data specific to the motor vehicle, or any combination thereof.

17. The electronic audiovisual system of claim 15, wherein the individual interests include similar user data indicative of interests of a similar user, the method further comprising calculating a similarity measure Sim(Uᵢ, Uⱼ) between the occupant Uᵢ and the similar user Uⱼ as:
$$Sim ( {U}_{i} , {U}_{j} ) = \frac{{\sum }_{{a}_{l} ∈ A} [ r ( {U}_{i} , {a}_{l} ) - \overline{r} ( {U}_{i} ) ] [ r ( {U}_{j} , {a}_{l} ) - \overline{r} ( {U}_{j} ) ]}{\sqrt{{\sum }_{{a}_{l} ∈ A} {[ r ( {U}_{i} , {a}_{l} ) - \overline{r} ( {U}_{i} ) ]}^{2}} \sqrt{{\sum }_{{a}_{l} ∈ A} {[ r ( {U}_{i} , {a}_{l} ) - \overline{r} ( {U}_{i} ) ]}^{2}}}$$
where r is a rating function of a user, r̅ is a mean of all ratings for a user, and a is a particular piece of content.

18. The electronic audiovisual system of claim 14, wherein the electronic control unit is further configured to determine, via a Scheduling & Ordering engine, an order of priority of the plurality of recommendations by assigning a priority indication and a time indication to each of the recommendations, wherein the recommendations are transmitted to the occupant through the electronic audiovisual system in the order of priority.

19. The electronic audiovisual system of claim 14, wherein the receiving the user selection includes receiving multiple user selections of multiple ones of the transmitted recommendations, the method further comprising creating a priority que of the selected recommendations, and scheduling a time to present each of the selected recommendations.

20. The electronic audiovisual system of claim 18, wherein the electronic control unit is further configured to receive vehicle-specific data associated with motor vehicle, wherein the determining the recommendations is further based on the received vehicle-specific data.
